(19) United States
(12) Patent Application Publication
(10) Pub. No.: US 2026/0252220 A1
(43) Pub. Date: Aug. 27, 2026

(54) CONFIGURATION OF DISPLAY LAYERS

(71) Applicant: Capital One Services, LLC, McLean, VA (US)

(72) Inventors: Bryan TAMAYO, Allen, TX (US); William MERKEL, Garland, TX (US)

(21) Appl. No.: 19/062,480

(22) Filed: Feb. 25, 2025

(51) Int. Cl. G06F 3/04842; G06F 3/04855

(52) U.S. Cl. CPC G06F 3/04842; G06F 3/04855; G06F 2203/04803

(57) ABSTRACT

In some implementations, a display layer configuration system may display, in a preview pane, a first display layer including a first display element indicating first content information and a second display element indicating second content information. The display layer configuration system may display a display layers palette including: a first graphical representation of the first display layer including a first graphical representation of the first display element indicating the first content information and a first graphical representation of the second display element indicating the second content information, and a first graphical representation of a second display layer including a second graphical representation of the first display element indicating third content information different from the first content information and a second graphical representation of the second display element indicating fourth content information different from the second content information.

### BACKGROUND

Web pages are typically designed with modular content (e.g., images, text, button user interface elements, or the like) in a static layout. For example, content on a web page is often arranged from left-to-right and top-to-bottom.

### SUMMARY

Some implementations described herein relate to a system for display layer configuration. The system may include one or more memories and one or more processors communicatively coupled to the one or more memories. The one or more processors may be configured to display, in a preview pane, a first display layer including a first display element indicating first content information and a second display element indicating second content information, wherein an area of the first display element is greater than an area of the second display element. The one or more processors may be configured to display a display layers palette including: a first graphical representation of the first display layer including a first graphical representation of the first display element indicating the first content information and a first graphical representation of the second display element indicating the second content information, wherein an area of the first graphical representation of the first display element is greater than an area of the first graphical representation of the second display element, and a first graphical representation of a second display layer including a second graphical representation of the first display element indicating third content information different from the first content information and a second graphical representation of the second display element indicating fourth content information different from the second content information, wherein an area of the second graphical representation of the first display element is greater than an area of the second graphical representation of the second display element, wherein the first graphical representation of the first display layer and the first graphical representation of the second display layer are arranged vertically, the first graphical representation of the first display element and the first graphical representation of the second display element are arranged horizontally, and the second graphical representation of the first display element and the second graphical representation of the second display element are arranged horizontally. The one or more processors may be configured to receive an indication to display the second display layer in the preview pane. The one or more processors may be configured to display, based on the indication, in the preview pane, the second display layer including the first display element indicating the third content information and the second display element indicating the fourth content information.

Some implementations described herein relate to a method of display layer configuration. The method may include displaying, in a preview pane, a first display layer including a first display element indicating first content information and a second display element indicating second content information, wherein an area of the first display element is greater than an area of the second display element. The method may include displaying a display layers palette including: a first graphical representation of the first display layer including a first graphical representation of the first display element indicating the first content information and a first graphical representation of the second display element indicating the second content information, wherein an area of the first graphical representation of the first display element is greater than an area of the first graphical representation of the second display element, and a first graphical representation of a second display layer including a second graphical representation of the first display element indicating third content information different from the first content information and a second graphical representation of the second display element indicating fourth content information different from the second content information, wherein an area of the second graphical representation of the first display element is greater than an area of the second graphical representation of the second display element. The method may include receiving an indication to display the second display layer in the preview pane. The method may include displaying, based on the indication, in the preview pane, the second display layer including the first display element indicating the third content information and the second display element indicating the fourth content information.

Some implementations described herein relate to a non-transitory computer-readable medium that stores a set of instructions. The set of instructions, when executed by one or more processors of a device, may cause the device to display, in a preview pane, a first display layer including a first display element indicating first content information and a second display element indicating second content information, wherein an area of the first display element is greater than an area of the second display element. The set of instructions, when executed by one or more processors of the device, may cause the device to display a display layers palette including: a first graphical representation of the first display layer including a first graphical representation of the first display element indicating the first content information and a first graphical representation of the second display element indicating the second content information, wherein an area of the first graphical representation of the first display element is greater than an area of the first graphical representation of the second display element, and a first graphical representation of a second display layer including a second graphical representation of the first display element indicating third content information different from the first content information and a second graphical representation of the second display element indicating fourth content information different from the second content information, wherein an area of the second graphical representation of the first display element is greater than an area of the second graphical representation of the second display element. The set of instructions, when executed by one or more processors of the device, may cause the device to display a timeline indicator including: a second graphical representation of the first display layer including a third graphical representation of the first display element indicating the first content information and a third graphical representation of the second display element indicating the second content information, wherein an area of the third graphical representation of the first display element is greater than an area of the third graphical representation of the second display element, and a second graphical representation of the second display layer including a fourth graphical representation of the first display element indicating the third content information and a fourth graphical representation of the second display element indicating the fourth content information, wherein an area of the fourth graphical representation of the first display element is greater than an area of the fourth graphical representation of the second display element. The set of instructions, when executed by one or more processors of the device, may cause the device to receive an indication to display the second display layer in the preview pane. The set of instructions, when executed by one or more processors of the device, may cause the device to display, based on the indication, in the preview pane, the second display layer including the first display element indicating the third content information and the second display element indicating the fourth content information.

### BRIEF DESCRIPTION OF THE DRAWINGS

FIGS. 1A-1B are diagrams of an example implementation associated with configuring display layers, in accordance with some embodiments of the present disclosure.

FIG. 2 is a diagram of an example functional workflow associated with configuring display layers, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with configuring display layers, in accordance with some embodiments of the present disclosure.

FIG. 5 is a flowchart of an example process associated with configuration of display layers, in accordance with some embodiments of the present disclosure.

### DETAILED DESCRIPTION

The following detailed description of example implementations refers to the accompanying drawings. The same reference numbers in different drawings may identify the same or similar elements.

A user interface of a user device, such as a user interface provided by a web browser, may include a web page for presentation via the user device. Typically, a user may scroll to information of interest on the web page or navigate to a different web page that contains the information of interest. For example, content on a web page may be presented linearly, such that a user must scroll vertically through the web page to view the content. Traditional web design relies heavily on vertical scrolling and linear content presentation. Vertical scrolling creates a poor user experience by limiting the flexibility and depth of user interaction, consumes excessive computing resources (e.g., processing resources and memory resources) that are needed for the user device to generate and display the portions of the web page during the scrolling, and consumes excessive network resources that are needed for communications between the user device and the server device. Additionally, or alternatively, if the information of interest is not available on the web page, then the user may navigate to one or more other web pages to attempt to locate the information of interest. For example, the web page may include buttons or hyperlinks to various other web pages in one or more navigational menus. Often, it may be difficult for a user to locate particular information of interest using a navigational menu. For example, descriptions of the navigational menu may be unintuitive and/or the user may need to click through navigational menus in multiple hierarchical levels in order to locate the information of interest. Navigating through a large number of web pages to find relevant information creates a poor user experience, consumes excessive computing resources (e.g., processing resources and memory resources) that are needed for the user device to generate and display the web pages and that are needed for one or more server devices to serve the web pages to the user device, and consumes excessive network resources that are needed for communications between the user device and the server device.

Some implementations described herein may enable efficient navigation in a user interface (e.g., a web-based tool, such as a user experience web design and development system) for a web page editor using depth-based web page design. In some examples, the user interface may display a z-index (e.g., a display layers palette) that shows a vertical layout showing different depth levels (e.g., display layers) that can be rendered visible on the web page. For example, one depth level may be displayed on the web page at a given time (the visible depth level may be considered to be “on top” of other depth levels on the web page). Thus, the user interface may provide a two-dimensional static interpretation of a three-dimensional (3D) z-space that includes the depth levels. In some examples, the user interface may enable editors to create and manage content in a depth-based layout for content presentation by dragging and dropping elements, grouping and ungrouping items, hiding layers, and navigating through content by selecting display layers. In some examples, once designed using the user interface, the web page may be deployed and visited by end users. Instead of scrolling through the web page and/or navigating to other web pages, these end users may cycle through content on the web page (e.g., at the top of a web page), transforming content through different prioritized states (e.g., corresponding to different depth levels) in a layout.

In some implementations, the user interface may include the z-index, a preview pane, and/or a timeline indicator. The preview pane may update in real-time, providing a visual preview of how content appears at various depth levels on the web page. The timeline indicator may be integrated into the z-index and enable the editor (e.g., a content creator) to cycle through depth levels vertically, providing a visual representation of content flow and depth and acting as a checkpoint where significant context changes in content occur. In some aspects, one or more of the display layers palette or the timeline indicator may include one or more scroll bars that can be created and/or moved (e.g., dragged) by the editor to navigate through different sections of content (e.g., through different depth levels). For example, the user interface may include multiple vertical scroll bars for navigating variations of content (e.g., the different depth levels), allowing the editor to create one or more sections (e.g., depth levels and/or display elements within the depth levels) as needed. For example, if the editor moves the scroll bar on the z-index, then the preview pane and the scroll bar on the timeline indicator may respond dynamically (e.g., the preview pane may change a display to a different depth level, and the scroll bar on the timeline indicator may move to the corresponding depth level). If the editor moves the scroll bar on the timeline indicator, then the preview pane and the scroll bar on the z-index may respond dynamically (e.g., the preview pane may change a display to a different depth level, and the scroll bar on the z-index may move to the corresponding depth level). Thus, the user interface may enable combining vertical layers with a draggable timeline indicator for intuitive and efficient editing.

By exploiting z-space in web page design, the user interface may conserve computing resources and/or network resources. For example, the user interface may enable a web page editor to design a web page that permits an end user to use a user device to cycle through content instead of vertically scrolling through the web page. As a result, the user interface may help to conserve computing resources (e.g., processing resources and memory resources) that would otherwise be needed for the user device to generate and display the portions of the web page during the scrolling, and/or network resources that would otherwise be needed for communications between the user device and the server device. For example, the user device (e.g., a mobile device) may lower power consumption (e.g., reduce power usage) by managing resources efficiently and thereby refraining from loading irrelevant content prompted by end user scrolling. For example, the user device may employ progressive lazy loading and dynamic content loading based on user interaction to reduce initial load times and, thus, improve web page performance. For example, instead of loading content concurrently, the user device may load content progressively (e.g., on an as-needed basis). For example, loading content on the web page may be curtailed due to interaction analysis of user engagement with the content designed for z-space elements. For example, the end user may trigger a modifier key or interface to engage with the content and thereby reduce an amount of unused content that would otherwise be fetched and held in a cache.

Additionally, or alternatively, the user interface may help the end user to locate information of interest on the web page and thereby reduce an amount of navigation performed by the end user. As a result, the user interface may conserve computing resources (e.g., processing resources, memory resources, and/or network resources) that would otherwise be needed for navigation of other web pages (e.g., resources for the user device to generate and display the web pages, resources for one or more server devices to serve the web pages to the user device, or the like). In some examples, instant feedback may help to facilitate fine-tuning of the user interface and further improve performance. Furthermore, the user interface makes web pages easier to design using z-space, and data easier to access by end users, thereby providing a cohesive, interactive, enhanced, dynamic, responsive, adaptive, and engaging user experience, enhancing user-friendliness of the user device and the user interface, and improving the ability of the editor to design the web page and/or the end user to interact with the web page. For example, the user interface and/or web page may present and manage complex, multi-faceted content effectively. In some examples, the user interface may provide an intuitive editing experience (e.g., multiple vertical scroll bars may provide flexibility for navigating complex content structures). In some examples, the web page may help to improve user experience by providing smooth transitions and interactive elements for facilitating cycling between different depth levels. In some examples, the user interface and/or web page may be scalable and/or have cross-platform compatibility such that the user interface and/or web page is compatible with various devices and browsers, thereby enhancing accessibility.

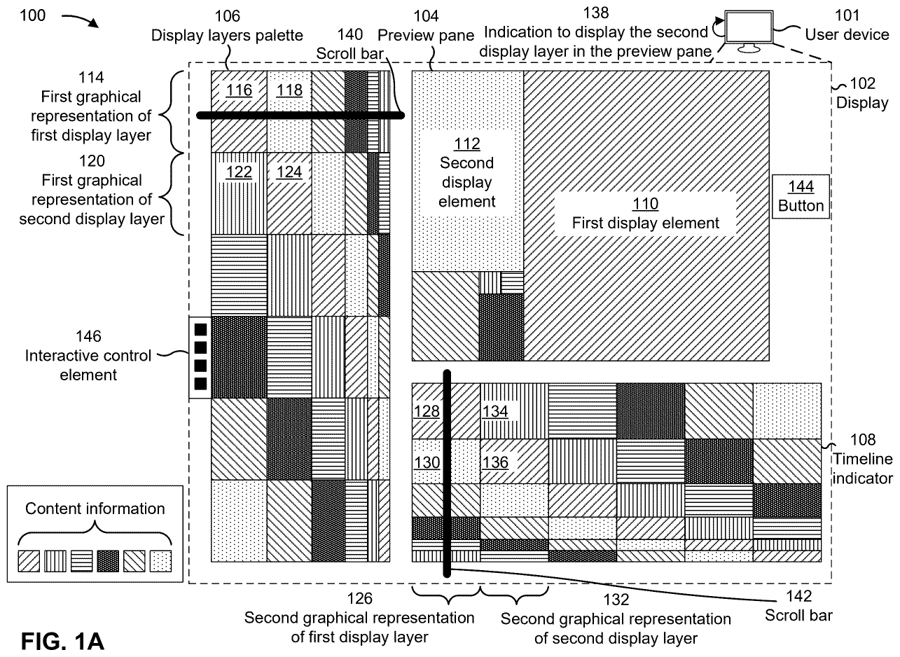

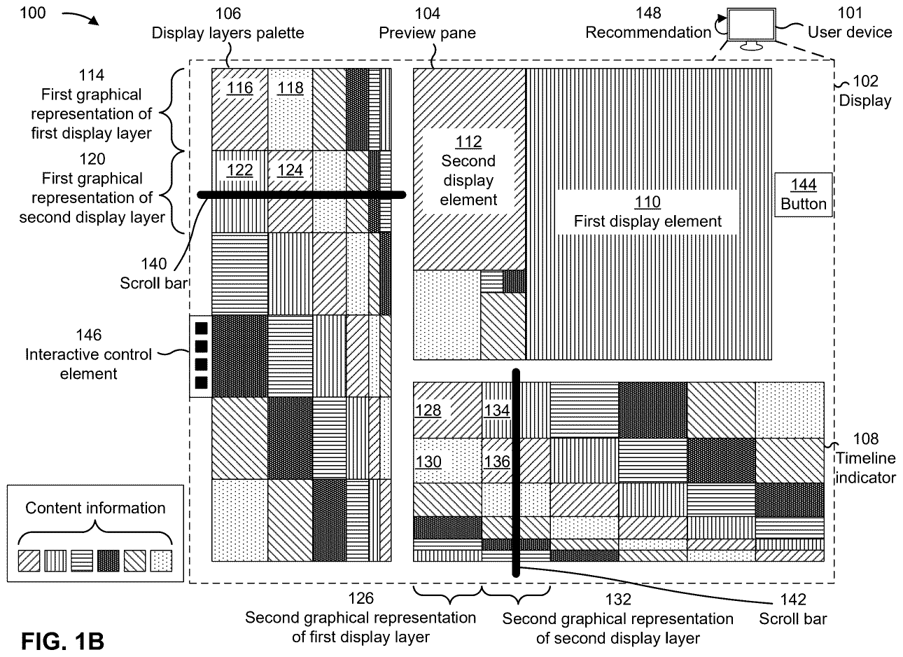

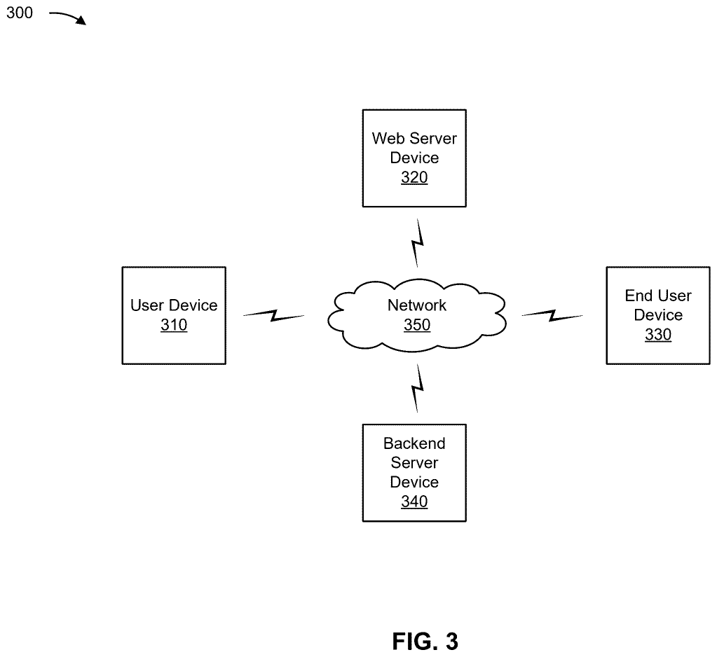

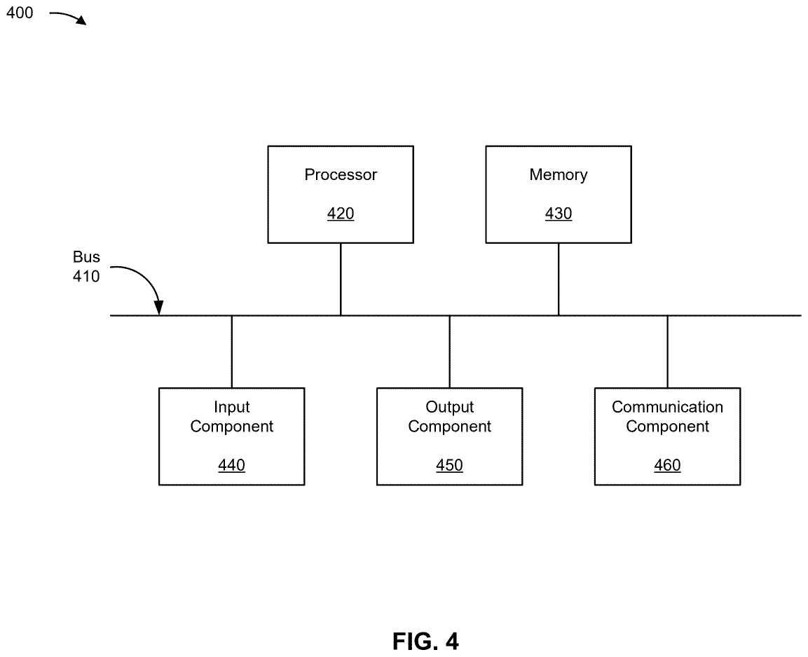

FIGS. 1A-1B are diagrams of an example implementation 100 associated with configuring display layers. As shown in FIGS. 1A-1B, example implementation 100 includes a user device 101, which is described in more detail below in connection with FIG. 3 and FIG. 4. As shown, the user device 101 includes a display 102 that shows a preview pane 104, a display layers palette 106, and a timeline indicator 108. In some examples, the user device 101 may be used by a web site designer or creator responsible for developing content and/or interactions for a web site. For example, the preview pane 104 may indicate a layout of a web page that is under design, and the display layers palette 106 and the timeline indicator 108 may be tools that aid the design of the web page. In some examples, the display layers palette 106 and the timeline indicator 108 may not be viewable by an end user of the web page.

With reference to FIG. 1A, in some aspects, the user device 101 may display, in the preview pane 104, a first display layer including a first display element 110 indicating first content information and a second display element 112 indicating second content information. For example, the first content information and the second content information may include web page material. In some examples, an area of the first display element 110 may be greater than an area of the second display element 112. The preview pane 104 may display any suitable quantity of display elements. For example, as shown, the preview pane 104 displays a total of six display elements having varying areas. Moreover, the preview pane 104 (e.g., and, thus, the web page) may display the display elements according to any suitable layout.

In some aspects, the display layers palette 106 may include a first graphical representation of the first display layer 114. The first graphical representation of the first display layer 114 may include a first graphical representation of the first display element 116 indicating the first content information and a first graphical representation of the second display element 118 indicating the second content information. In some examples, an area of the first graphical representation of the first display element 116 may be greater than an area of the first graphical representation of the second display element 118. For example, the first graphical representation of the first display element 116 and the first display element 110 may have greater areas than the first graphical representation of the second display element 118 and the second display element 112, respectively. The first graphical representation of the first display layer 114 may include any suitable quantity of graphical representations of display elements. For example, as shown, the first graphical representation of the first display layer 114 includes a total of six graphical representations of display elements having varying areas.

In some aspects, the display layers palette 106 may include a first graphical representation of the second display layer 120. The first graphical representation of the second display layer 120 may include a second graphical representation of the first display element 122 indicating third content information and a second graphical representation of the second display element 124 indicating fourth content information. In some examples, an area of the second graphical representation of the first display element 122 may be greater than an area of the second graphical representation of the second display element 124. For example, the second graphical representation of the first display element 122 and the first display element 110 may have greater areas than the second graphical representation of the second display element 124 and the second display element 112, respectively. The first graphical representation of the second display layer 120 may include any suitable quantity of graphical representations of display elements. For example, as shown, the first graphical representation of the second display layer 120 includes a total of six graphical representations of display elements having varying areas. Furthermore, the display layers palette 106 may include any suitable quantity of graphical representations of display layers. For example, as shown, the display layers palette 106 may include a total of six graphical representations of display layers.

In some aspects, the third content information may be different from the first content information. For example, the second graphical representation of the first display element 122 may indicate different content information than that indicated by the first graphical representation of the first display element 116. In some aspects, the fourth content information may be different from the second content information. For example, the second graphical representation of the second display element 124 may indicate different content information than that indicated by the first graphical representation of the second display element 118.

In some examples, the third content information may be the same as or different from the second content information (e.g., second graphical representation of the first display element 122 and the first graphical representation of the second display element 118 may indicate the same or different content information). In some examples, the fourth content information may be the same as or different from the first content information (e.g., second graphical representation of the second display element 124 and the first graphical representation of the first display element 116 may indicate the same or different content information). For example, as shown, the second content information and the third content information are different, and the first content information and the fourth content information are the same. In some examples, the content information indicated by the graphical representations of display elements in the first graphical representation of the first display layer 114 may be iterated in the first graphical representation of the second display layer 120. For example, as shown, the second graphical representation of the second display element 124 indicates the same content information as that indicated by the first graphical representation of the first display element 116, a second graphical representation of a third display element in the first graphical representation of the second display layer 120 may indicate the same content information as that indicated by the first graphical representation of the second display element 118, and so forth.

In some aspects, the first graphical representation of the first display layer 114 and the first graphical representation of the second display layer 120 may be arranged vertically. For example, as shown, all graphical representations of display layers included in the display layers palette 106 may be arranged vertically. In some aspects, the first graphical representation of the first display element 116 and the first graphical representation of the second display element 118 may be arranged horizontally. For example, as shown, all graphical representations of display layers included in the first graphical representation of the first display layer 114 may be arranged vertically. In some aspects, the second graphical representation of the first display element 122 and the second graphical representation of the second display element 124 may be arranged horizontally. For example, as shown, all graphical representations of display layers included in the first graphical representation of the second display layer 120 may be arranged vertically.

In some aspects, the timeline indicator 108 may include a second graphical representation of the first display layer 126. The second graphical representation of the first display layer 126 may include a third graphical representation of the first display element 128 indicating the first content information and a third graphical representation of the second display element 130 indicating the second content information. In some examples, an area of the third graphical representation of the first display element 128 may be greater than an area of the third graphical representation of the second display element 130. For example, the third graphical representation of the first display element 128 and the first display element 110 may have greater areas than the third graphical representation of the second display element 130 and the second display element 112, respectively. The second graphical representation of the first display layer 126 may include any suitable quantity of graphical representations of display elements. For example, as shown, the second graphical representation of the first display layer 126 includes a total of six graphical representations of display elements having varying areas.

In some aspects, the timeline indicator 108 may include a second graphical representation of the second display layer 132. The second graphical representation of the second display layer 132 may include a fourth graphical representation of the first display element 134 indicating the third content information and a fourth graphical representation of the second display element 136 indicating the fourth content information. In some examples, an area of the fourth graphical representation of the first display element 134 may be greater than an area of the fourth graphical representation of the second display element 136. For example, the fourth graphical representation of the first display element 134 and the first display element 110 may have greater areas than the fourth graphical representation of the second display element 136 and the second display element 112, respectively. The second graphical representation of the second display layer 132 may include any suitable quantity of graphical representations of display elements. For example, as shown, the second graphical representation of the second display layer 132 includes a total of six graphical representations of display elements having varying areas. Furthermore, the timeline indicator 108 may include any suitable quantity of graphical representations of display layers. For example, as shown, the timeline indicator 108 may include a total of six graphical representations of display layers.

In some aspects, the second graphical representation of the first display layer 126 and the second graphical representation of the second display layer 132 may be arranged horizontally. For example, as shown, all graphical representations of display layers included in the timeline indicator 108 may be arranged horizontally. In some aspects, the third graphical representation of the first display element 128 and the third graphical representation of the second display element 130 may be arranged vertically. For example, as shown, all graphical representations of display layers included in the second graphical representation of the first display layer 126 may be arranged vertically. In some aspects, the fourth graphical representation of the first display element 134 and the fourth graphical representation of the second display element 136 may be arranged vertically. For example, as shown, all graphical representations of display layers included in the second graphical representation of the second display layer 132 may be arranged vertically.

As shown by reference number 138, the user device 101 may receive an indication to display the second display layer in the preview pane. For example, the indication may prompt the user device 101 to update the preview pane such that the first display element indicates the third content information, the second display element indicates the fourth content information, and so forth.

In some aspects, the indication may be a scroll bar 140 overlaid on the first graphical representation of the second display layer 120. As shown in FIG. 1A, the scroll bar 140 is overlaid on the first graphical representation of the first display layer 114 of the display layers palette 106, and the preview pane displays the first display layer accordingly. In some examples, the scroll bar 140 may be draggable. For example, the scroll bar 140 may be dragged to a position such that the scroll bar 140 is overlaid on the first graphical representation of the second display layer 120, which may prompt the user device 101 to update the preview pane to display the second display layer accordingly.

In some aspects, the indication may be a scroll bar 142 overlaid on the second graphical representation of the second display layer 132. As shown in FIG. 1A, the scroll bar 142 is overlaid on the second graphical representation of the first display layer 114 of the timeline indicator 108, and the preview pane displays the first display layer accordingly. In some examples, the scroll bar 142 may be draggable. For example, the scroll bar 142 may be dragged to a position such that the scroll bar 142 is overlaid on the second graphical representation of the second display layer 132, which may prompt the user device 101 to update the preview pane to display the second display layer accordingly.

In some aspects, the first display layer and the second display layer are end-user-selectable. For example, the end user may use an interface modifier button 144 to switch between different display layers (e.g., between all six display layers, including the first display layer and the second display layer) on the web page. For example, if the user device 101 is a desktop, then the end user may trigger the interface modifier button 144 by holding a shift button and hover-scrolling. If the user device 101 is a mobile device, then the end user may trigger the interface modifier button 144 by performing a long press (e.g., on a touchscreen) and scrolling in a section on the web page. In this manner, the end user may toggle between different sizes for different content without scrolling through the web page itself.

In some aspects, the user device 101 may display an interactive control element 146 that enables configuration of an animated transition between the first display layer and the second display layer. For example, the animated transition may show the first content moving from the first display element 110 to the second display element 112, the second content moving from the second display element 112 to a third display element, and so forth. In some examples, the interactive control element 146 (e.g., an icon, a user interface, or the like) may be a hover or slide-out user interface that provides multiple contextual options (e.g., adding transitions, animations, interactive elements, 3D transformations, 3D rendering, or the like). Although only a single interactive control element is shown in FIG. 1A, in other examples, multiple interactive control elements may be displayed. For example, each graphical representation of a display layer in the display layers palette 106 may have a corresponding interactive control element that enables configuration of an animated transition for that display layer.

With reference to FIG. 1B, in some aspects, the user device 101 may display, based on the indication, in the preview pane 104, the second display layer including the first display element 110 indicating the third content information and the second display element 112 indicating the fourth content information. As shown in FIG. 1B, the scroll bar 140 is overlaid on the first graphical representation of the second display layer 120, and the scroll bar 142 is overlaid on the second graphical representation of the second display layer 132. Accordingly, the content information in each display element of the preview pane 104 is iterated, as compared to the preview pane 104 as shown in FIG. 1A. In some examples, the scroll bars 140 and/or 142 may be overlaid on any graphical representation of a display layer shown in the display layers palette 106 and/or the timeline indicator 108, and the content information in each display element of the preview pane 104 may be updated accordingly.

As shown by reference number 148, the user device 101 may receive, based on user feedback, a recommendation associated with the first display layer and the second display layer. For example, the web page may be deployed and visited by a user, and the user may provide user feedback. In some examples, the user feedback may indicate implicit feedback, such as a level of user engagement with content displayed on the web page. In some examples, the user feedback information may indicate explicit feedback, such as a user response to a prompt (e.g., a questionnaire) for the user feedback. The recommendation may be associated with the first display layer and the second display layer in that the recommendation may suggest a course of action with respect to the design of the first display layer and the second display layer. For example, the recommendation may suggest one or more changes to the first display layer and/or the second display layer (e.g., regarding how content is displayed in one or more of the display elements).

As indicated above, FIGS. 1A-1B are provided as an example. Other examples may differ from what is described with regard to FIGS. 1A-1B. The number and arrangement of devices shown in FIGS. 1A-1B are provided as an example. In practice, there may be additional devices, fewer devices, different devices, or differently arranged devices than those shown in FIGS. 1A-1B. Furthermore, two or more devices shown in FIGS. 1A-1B may be implemented within a single device, or a single device shown in FIGS. 1A-1B may be implemented as multiple, distributed devices. Additionally, or alternatively, a set of devices (e.g., one or more devices) shown in FIGS. 1A-1B may perform one or more functions described as being performed by another set of devices shown in FIGS. 1A-1B.

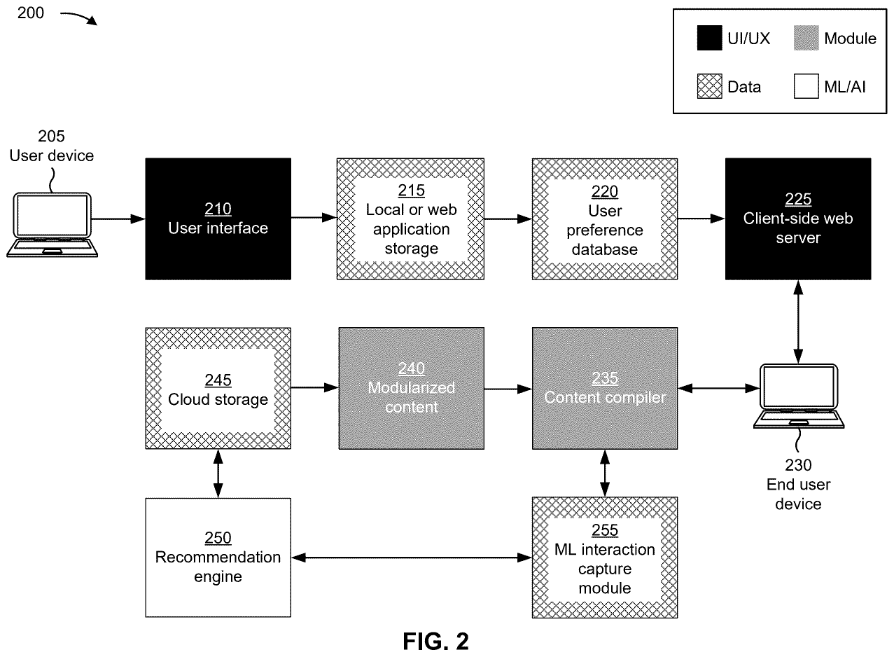

FIG. 2 is a diagram of an example functional workflow 200 associated with configuring display layers. The functional workflow 200 includes a user device 205, a user interface 210, local or web application storage 215, a user preference database 220, a client-side web server 225, an end user device 230, a content compiler 235, modularized content 240, cloud storage 24, a recommendation engine 250, and a machine learning interaction capture module 255.

The user device 205 may be used by a web site designer or creator (e.g., the user device 205 may be the user device 101). The user device 205 may be compatible with any suitable web browser, and may be a desktop, a tablet, a smartphone, or the like. In some examples, the user device 205 may comprise multiple screens or multiple devices that allow viewing of multiple web pages simultaneously. The user interface 210 may be displayed on the user device 205 (e.g., the user interface 210 may be shown in the display 102 of the user device 101 in FIGS. 1A-1B). The local or web application storage 215 may store interactions of the user interface 210 (e.g., a user interface application). The user preference database 220 may store application preferences for individual users and/or applications concerning content creation. In some examples, the user preference database 220 may be a back-end database that offers flexible and/or scalable data storage.

The client-side web server 225 may provide a front-end display for the end user device 230. The client-side web server 225 may include application programming interface (API) connectors to the user preference database 220 and/or other components, compilers, or the like. In some examples, the client-side web server 225 may be a high-performance server that uses multi-core processors and ample random access memory (RAM) for handling dynamic content loading and rendering. The end user device 230 may be used by an end user of the web page. The end user device 230 may be compatible with any suitable web browser, and may be a desktop, a tablet, a smartphone, or the like. In some examples, the end user device 230 may comprise multiple screens or multiple devices that allow viewing of multiple web pages simultaneously.

The content compiler 235 may responsively compile content components as individualized assets into a flexible client-side server user interface. The modularized content 240 may include content modules (e.g., modules of individual pieces of content) that are arranged according to the layout designed using the user interface 210. In some examples, the modularized content may be populated in real-time to the user interface 210 to indicate how each content module reacted in different states (e.g., display layers) of the user interface 210. The cloud storage 245 may store individual content assets in an object-oriented manner for variable and flexible use in real-time compiling at scale. The recommendation engine may generate predictions (e.g., recommendations as discussed above in connection with reference number 148) for the content designer and/or the user to help improve user engagement based on which user(s) are the most engaged and with what content. The machine learning capture module 255 may capture interactions indicating user preferences in connection with the design of the user interface 210. In some examples, one or more components on other web pages may be integrated into the functional workflow 200 such that engagement insights may be synchronized and continuously input into the machine learning interaction capture module 255 and/or the recommendation engine 250.

As indicated above, FIG. 2 is provided as an example. Other examples may differ from what is described with regard to FIG. 2.

Displaying the preview pane and display layers palette may help to conserve computing resources and/or network resources. For example, the user interface may enable a web page editor to design a web page that permits an end user to use a user device to cycle through content instead of vertically scrolling through the web page. As a result, the user interface may help to conserve computing resources (e.g., processing resources and memory resources) that would otherwise be needed for the user device to generate and display the portions of the web page during the scrolling and/or network resources that would otherwise be needed for communications between the user device and the server device. For example, the user device (e.g., a mobile device) may lower power consumption (e.g., reduce power usage) by managing resources efficiently and thereby refraining from loading irrelevant content prompted by end user scrolling. For example, the user device may employ progressive lazy loading and dynamic content loading based on user interaction to reduce initial load times and, thus, improve web page performance. For example, instead of loading content concurrently, the user device may load content progressively (e.g., on an as-needed basis). For example, loading content on the web page may be curtailed due to interaction analysis of user engagement with the content designed for z-space elements. For example, the end user may trigger a modifier key or interface to engage with the content and thereby reduce an amount of unused content that would otherwise be fetched and held in a cache.

Additionally, or alternatively, displaying the preview pane and display layers palette may help the end user to locate information of interest on the web page and thereby reduce an amount of navigation performed by the end user. As a result, the user interface may conserve computing resources (e.g., processing resources, memory resources, and/or network resources) that would otherwise be needed for navigation of other web pages (e.g., resources for the user device to generate and display the web pages, resources for one or more server devices to serve the web pages to the user device, or the like). In some examples, instant feedback may help to facilitate fine-tuning of the user interface and further improve performance. Furthermore, the preview pane and display layers palette may make web pages easier to design using z-space and data easier to access by end users, thereby providing a cohesive, interactive, enhanced, dynamic, responsive, adaptive, and engaging user experience, enhancing user-friendliness of the user device and the user interface, and improving the ability of the editor to design the web page and/or the end user to interact with the web page. For example, the user interface and/or web page may present and manage complex, multi-faceted content effectively. In some examples, the user interface may provide an intuitive editing experience (e.g., multiple vertical scroll bars may provide flexibility for navigating complex content structures). In some examples, the web page may help to improve user experience by providing smooth transitions and interactive elements for facilitating cycling between different depth levels. In some examples, the user interface and/or web page may be scalable and/or have cross-platform compatibility such that the user interface and/or web page is compatible with various devices and browsers, thereby enhancing accessibility.

FIG. 3 is a diagram of an example environment 300 in which systems and/or methods described herein may be implemented. As shown in FIG. 3, environment 300 may include a user device 310, a web server device 320, an end user device 330, a backend server device 340, and a network 350. Devices of environment 300 may interconnect via wired connections, wireless connections, or a combination of wired and wireless connections.

The user device 310 may include one or more devices capable of receiving, generating, storing, processing, and/or providing information associated with configuring display layers, as described elsewhere herein. For example, the user device 310 may be used by a web site designer or creator (e.g., the user device 310 may be the user device 205 or the user device 101). In some examples, the user device 310 may include a communication device and/or a computing device. For example, the user device 310 may include a wireless communication device, a mobile phone, a user equipment, a laptop computer, a tablet computer, a desktop computer, or a similar type of device.

The web server device 320 may include one or more devices capable of receiving, generating, storing, processing, providing, and/or routing information associated with configuring display layers, as described elsewhere herein. The web server device 320 may host the web page visited by the end user. In some examples, the web server device 320 may include a communication device and/or a computing device. For example, the web server device 320 may include a server, such as an application server, a client server, a web server, a proxy server, a virtual server (e.g., executing on computing hardware), or a server in a cloud computing system. In some implementations, the web server device 320 may include computing hardware used in a cloud computing environment, such as one or more serverless components (e.g., one or more serverless functions).

The end user device 330 may include one or more devices capable of receiving, generating, storing, processing, and/or providing information associated with configuring display layers, as described elsewhere herein. For example, the end user device 330 may be used by an end user to visit the web site (e.g., the end user device 330 may be the end user device 230). In some examples, the end user device 330 may include a communication device and/or a computing device. For example, the end user device 330 may include a wireless communication device, a mobile phone, a user equipment, a laptop computer, a tablet computer, a desktop computer, or a similar type of device.

The backend server device 340 may include one or more devices capable of receiving, generating, storing, processing, providing, and/or routing information associated with configuring display layers, as described elsewhere herein. For example, the backend server device 340 may perform certain backend functions, such as generating recommendations regarding the user interface 210. In some examples, the backend server device 340 may include a communication device and/or a computing device. For example, the backend server device 340 may include a server, such as an application server, a client server, a web server, a database server, a host server, a proxy server, a virtual server (e.g., executing on computing hardware), or a server in a cloud computing system. In some implementations, the backend server device 340 may include computing hardware used in a cloud computing environment, such as one or more serverless components (e.g., one or more serverless functions), among other examples.

The network 350 may include one or more wired and/or wireless networks. For example, the network 350 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 350 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with configuring display layers. The device 400 corresponds to one or more of user device 310, web server device 320, end user device 330, and/or backend server device 340. In some implementations, user device 310, web server device 320, end user device 330, and/or backend server device 340 include one or more devices 400 and/or one or more components of the device 400. In the example shown in FIG. 4, the device 400 includes a bus 410, a processor 420, a memory 430, an input component 440, an output component 450, and/or a communication component 460.

The bus 410 includes one or more components that enable wired and/or wireless communication among the components of the device 400. The bus 410 couples together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 includes a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory, such as RAM, read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). In some implementations, the memory 430 is a non-transitory computer-readable medium. The memory 430 stores information, one or more instructions, and/or software (e.g., one or more software applications) related to the operation of the device 400. In some implementations, the memory 430 includes one or more memories that are coupled (e.g., communicatively coupled) to one or more processors (e.g., processor 420), such as via the bus 410. Communicative coupling between a processor 420 and a memory 430 enables the processor 420 to read and/or process information stored in the memory 430 and/or to store information in the memory 430.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

In some implementations, the device 400 performs one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

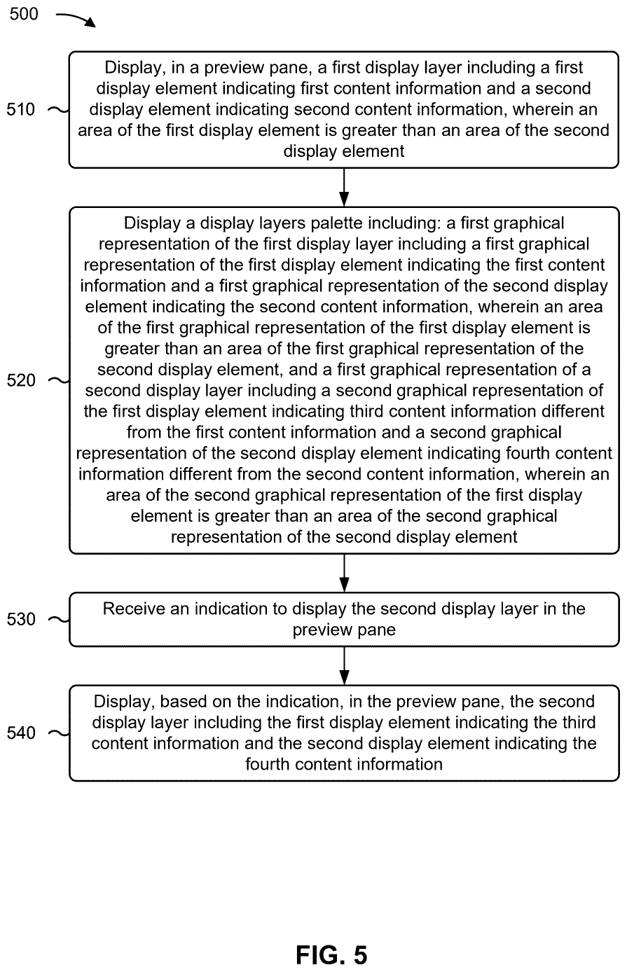

FIG. 5 is a flowchart of an example process 500 associated with configuration of display layers. In some implementations, one or more process blocks of FIG. 5 may be performed by the user device 310. In some implementations, one or more process blocks of FIG. 5 may be performed by another device or a group of devices separate from or including the user device 310, such as the web server device 320, the end user device 330, and/or the backend server device 340. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include displaying, in a preview pane, a first display layer including a first display element indicating first content information and a second display element indicating second content information (block 510). For example, the user device 310 (e.g., using processor 420, memory 430, and/or output component 450) may display, in a preview pane, a first display layer including a first display element indicating first content information and a second display element indicating second content information, as described above in connection with FIG. 1A. As an example, the first content information and the second content information may include web page material. In some implementations, an area of the first display element is greater than an area of the second display element.

As further shown in FIG. 5, process 500 may include displaying a display layers palette including: a first graphical representation of the first display layer including a first graphical representation of the first display element indicating the first content information and a first graphical representation of the second display element indicating the second content information, and a first graphical representation of a second display layer including a second graphical representation of the first display element indicating third content information different from the first content information and a second graphical representation of the second display element indicating fourth content information different from the second content information (block 520). For example, the user device 310 (e.g., using processor 420, memory 430, and/or output component 450) may display a display layers palette including: a first graphical representation of the first display layer including a first graphical representation of the first display element indicating the first content information and a first graphical representation of the second display element indicating the second content information, and a first graphical representation of a second display layer including a second graphical representation of the first display element indicating third content information different from the first content information and a second graphical representation of the second display element indicating fourth content information different from the second content information, as described above in connection with FIG. 1A. As an example, the third content information may be different from the first content information, and/or the fourth content information may be different from the second content information. In some implementations, an area of the first graphical representation of the first display element is greater than an area of the first graphical representation of the second display element. In some implementations, an area of the second graphical representation of the first display element is greater than an area of the second graphical representation of the second display element.

As further shown in FIG. 5, process 500 may include receiving an indication to display the second display layer in the preview pane (block 530). For example, the user device 310 (e.g., using processor 420, memory 430, input component 440, and/or communication component 460) may receive an indication to display the second display layer in the preview pane, as described above in connection with reference number 138 of FIG. 1A. As an example, the indication may prompt the first display element to indicate the third content information, the second display element to indicate the fourth content information, and so forth.

As further shown in FIG. 5, process 500 may include displaying, based on the indication, in the preview pane, the second display layer including the first display element indicating the third content information and the second display element indicating the fourth content information (block 540). For example, the user device 310 (e.g., using processor 420, memory 430, and/or output component 450) may display, based on the indication, in the preview pane, the second display layer including the first display element indicating the third content information and the second display element indicating the fourth content information, as described above in connection with FIG. 1B. As an example, the content information in each display element of the preview pane may be iterated compared to a priori display of the preview pane.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A, 1B, and/or 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for display layer configuration, the system comprising:
one or more memories; and
one or more processors, communicatively coupled to the one or more memories, configured to:
display, in a preview pane, a first display layer including a first display element indicating first content information and a second display element indicating second content information, wherein an area of the first display element is greater than an area of the second display element;
display a display layers palette including:
a first graphical representation of the first display layer including a first graphical representation of the first display element indicating the first content information and a first graphical representation of the second display element indicating the second content information, wherein an area of the first graphical representation of the first display element is greater than an area of the first graphical representation of the second display element, and
a first graphical representation of a second display layer including a second graphical representation of the first display element indicating third content information different from the first content information and a second graphical representation of the second display element indicating fourth content information different from the second content information, wherein an area of the second graphical representation of the first display element is greater than an area of the second graphical representation of the second display element,
wherein the first graphical representation of the first display layer and the first graphical representation of the second display layer are arranged vertically, the first graphical representation of the first display element and the first graphical representation of the second display element are arranged horizontally, and the second graphical representation of the first display element and the second graphical representation of the second display element are arranged horizontally;
receive an indication to display the second display layer in the preview pane; and
display, based on the indication, in the preview pane, the second display layer including the first display element indicating the third content information and the second display element indicating the fourth content information.

2. The system of claim 1, wherein the indication comprises a scroll bar overlaid on the first graphical representation of the second display layer.

3. The system of claim 1, wherein the one or more processors are further configured to:
display a timeline indicator including:
a second graphical representation of the first display layer including a third graphical representation of the first display element indicating the first content information and
a third graphical representation of the second display element indicating the second content information, wherein an area of the third graphical representation of the first display element is greater than an area of the third graphical representation of the second display element, and
a second graphical representation of the second display layer including a fourth graphical representation of the first display element indicating the third content information and a fourth graphical representation of the second display element indicating the fourth content information, wherein an area of the fourth graphical representation of the first display element is greater than an area of the fourth graphical representation of the second display element.

4. The system of claim 3, wherein the second graphical representation of the first display layer and the second graphical representation of the second display layer are arranged horizontally, the third graphical representation of the first display element and the third graphical representation of the second display element are arranged vertically, and the fourth graphical representation of the first display element and the fourth graphical representation of the second display element are arranged vertically.

5. The system of claim 3, wherein the indication comprises a scroll bar overlaid on the second graphical representation of the second display layer.

6. The system of claim 1, wherein the first display layer and the second display layer are end-user-selectable.

7. The system of claim 1, wherein the one or more processors are further configured to:
display an interactive control element that enables configuration of an animated transition between the first display layer and the second display layer.

8. The system of claim 1, wherein the one or more processors are further configured to:
receive, based on user feedback, a recommendation associated with the first display layer and the second display layer.

9. A method of display layer configuration, comprising:
displaying, in a preview pane, a first display layer including a first display element indicating first content information and a second display element indicating second content information, wherein an area of the first display element is greater than an area of the second display element;
displaying a display layers palette including:
a first graphical representation of the first display layer including a first graphical representation of the first display element indicating the first content information and a first graphical representation of the second display element indicating the second content information, wherein an area of the first graphical representation of the first display element is greater than an area of the first graphical representation of the second display element, and
a first graphical representation of a second display layer including a second graphical representation of the first display element indicating third content information different from the first content information and a second graphical representation of the second display element indicating fourth content information different from the second content information, wherein an area of the second graphical representation of the first display element is greater than an area of the second graphical representation of the second display element;
receiving an indication to display the second display layer in the preview pane; and
displaying, based on the indication, in the preview pane, the second display layer including the first display element indicating the third content information and the second display element indicating the fourth content information.

10. The method of claim 9, wherein the first graphical representation of the first display layer and the first graphical representation of the second display layer are arranged vertically, the first graphical representation of the first display element and the first graphical representation of the second display element are arranged horizontally, and the second graphical representation of the first display element and the second graphical representation of the second display element are arranged horizontally.

11. The method of claim 9, wherein the indication comprises a scroll bar overlaid on the first graphical representation of the second display layer.

12. The method of claim 9, further comprising:
displaying a timeline indicator including:
a second graphical representation of the first display layer including a third graphical representation of the first display element indicating the first content information and a third graphical representation of the second display element indicating the second content information, wherein an area of the third graphical representation of the first display element is greater than an area of the third graphical representation of the second display element, and
a second graphical representation of the second display layer including a fourth graphical representation of the first display element indicating the third content information and a fourth graphical representation of the second display element indicating the fourth content information, wherein an area of the fourth graphical representation of the first display element is greater than an area of the fourth graphical representation of the second display element.

13. The method of claim 12, wherein the second graphical representation of the first display layer and the second graphical representation of the second display layer are arranged horizontally, the third graphical representation of the first display element and the third graphical representation of the second display element are arranged vertically, and the fourth graphical representation of the first display element and the fourth graphical representation of the second display element are arranged vertically.

14. The method of claim 12, wherein the indication comprises a scroll bar overlaid on the second graphical representation of the second display layer.

15. The method of claim 9, wherein the first display layer and the second display layer are end-user-selectable.

16. The method of claim 9, further comprising:
displaying an interactive control element that enables configuration of an animated transition between the first display layer and the second display layer.

17. The method of claim 9, further comprising:
receiving, based on user feedback, a recommendation associated with the first display layer and the second display layer.

18. A non-transitory computer-readable medium storing a set of instructions, the set of instructions comprising:
one or more instructions that, when executed by one or more processors of a device, cause the device to:
display, in a preview pane, a first display layer including a first display element indicating first content information and a second display element indicating second content information, wherein an area of the first display element is greater than an area of the second display element;
display a display layers palette including:
a first graphical representation of the first display layer including a first graphical representation of the first display element indicating the first content information and a first graphical representation of the second display element indicating the second content information, wherein an area of the first graphical representation of the first display element is greater than an area of the first graphical representation of the second display element, and
a first graphical representation of a second display layer including a second graphical representation of the first display element indicating third content information different from the first content information and a second graphical representation of the second display element indicating fourth content information different from the second content information, wherein an area of the second graphical representation of the first display element is greater than an area of the second graphical representation of the second display element;
display a timeline indicator including:
a second graphical representation of the first display layer including a third graphical representation of the first display element indicating the first content information and
a third graphical representation of the second display element indicating the second content information, wherein an area of the third graphical representation of the first display element is greater than an area of the third graphical representation of the second display element, and
a second graphical representation of the second display layer including a fourth graphical representation of the first display element indicating the third content information and a fourth graphical representation of the second display element indicating the fourth content information, wherein an area of the fourth graphical representation of the first display element is greater than an area of the fourth graphical representation of the second display element;
receive an indication to display the second display layer in the preview pane; and
display, based on the indication, in the preview pane, the second display layer including the first display element indicating the third content information and the second display element indicating the fourth content information.

19. The non-transitory computer-readable medium of claim 18, wherein the first graphical representation of the first display layer and the first graphical representation of the second display layer are arranged vertically, the first graphical representation of the first display element and the first graphical representation of the second display element are arranged horizontally, and the second graphical representation of the first display element and the second graphical representation of the second display element are arranged horizontally.

20. The non-transitory computer-readable medium of claim 18, wherein the indication comprises a scroll bar overlaid on the first graphical representation of the second display layer.
